(19) United States
(12) Patent Application Publication
(10) Pub. No.: US 2014/0145107 A1
(43) Pub. Date: May 29, 2014

(54) Heat Exchangers Using Metallic Foams on Fins

(71) Applicant: MASSACHUSETTS INSTITUTE OF TECHNOLOGY, CAMBRIDGE, MA (US)

(72) Inventors: Leslie Bromberg, Sharon, MA (US); Daniel R. Cohn, Cambridge, MA (US)

(21) Appl. No.: 14/084,724

(22) Filed: Nov. 20, 2013

Related U.S. Application Data
(60) Provisional application No. 61/730,586, filed on Nov. 28, 2012.

(51) Int. Cl. C09K 5/14; B01J 35/04

(52) U.S. Cl. CPC C09K 5/14; B01J 35/04
USPC 252/71; 165/185

(57) ABSTRACT

Heat exchanger. Metallic foam is disposed on at least one fin made of high thermal conductivity material. The metallic foam exchanges heat with a gas stream flowing therethrough.

This application claims priority to provisional application Ser. No. 61/730,586 filed on Nov. 28, 2012, the contents of which are incorporated herein by reference.

### BACKGROUND OF THE INVENTION

This invention relates to heat exchangers and more particularly to a heat exchanger that uses metallic foam disposed on a fin made of a high thermal conductivity material.

Improved gas to gas heat exchangers can provide significant advantages for a range of applications. Improvement has been challenging because when the heat exchange involves gases, heat transfer is low and the heat exchangers are bulky.

Metallic foams have been proposed recently as better components for heat exchangers but present designs for their employment have substantial limitations for use in gas to gas heat exchangers.

Although metallic foams have excellent performance for exchanging thermal energy between the gas and the foam (due to large surface-to-volume, and high surface heat transfer coefficient due to the small scale of the cross-elements in the foam), they have particularly low thermal conductivity. For a material with 92% porosity, the thermal conductivity is about 1/11 that of the full dense material. And because of tortuosity (tortuosity is defined as a meandering path the heat needs to take through a porous medium) of the connections the thermal conductivity decreases again by another factor of ⅓. Thus, the thermal conductivity of the material is about 1/35 that of the base metal. Substantial temperature gradients occur in the material, unless other material is used to help in the heat transfer.

Thus, for proper design, the foam cannot be too thick or too far from the surface across which the heat transfers between the two heat exchanging substances (e.g. between two gases).

Metallic foam heat exchangers have been discussed for removing heat in applications that do not involve gas-to-gas heat exchange. These heat exchangers are not optimized for heat transfer. Huang et al. (US patent application 2006/0137862 A1, published June 2006) describes a metallic foam with a heat transferring device to distribute the heat into the metallic foam. Once the thermal energy is in the foam it can be efficiently removed by the gas stream (air). The heat transferring device can be a rounded heat pipe, a loop-type heat pipe, a pulsating heat pipe, or a solid element made of thermally conductive metals. Meng et al. (U.S. Pat. No. 7,987,898, August 2011) describe a similar approach as Huang, but the heat transferring device is a heat pipe. Multiple holes for the heat pipes, as well as various heat pipe cross sections are described.

Mornet et al. (US patent application US 2011/0315342 A1) describes a heat exchanger device, in which a metallic foam is used to cool a metallic element. He does not describe the use of gas-to-gas heat exchanger. Ozmat (U.S. Pat. No. 6,397,450, June 2002) describes the use of a metallic foam in contact with an electronic device, for cooling the electronic device. He does not describe a gas-to-gas heat exchanger.

The use of foams in heat exchangers is described by Kang (B. H. Kang, S. Y. Kin, D. Y. Lee et al., Plate Tube Type Heat Exchanger Having Porous Fins, U.S. Pat. No. 6,142,222 (November 2000). It is assumed that the heat is conducted exclusively by the metallic foam, with no solid material to aid in heat transfer across the metallic foams. Kienbock et al. (Heat Exchanger for Industrial Applications, US patent application US20050178534A1) also describe another embodiment of a heat exchanger with porous foam. They use the porous foam only in one of their channels. They use the “high thermal conductivity” of the foam to distribute the heat through the channel.

The patents described above do not discuss use of metallic foams in gas-to-gas heat exchangers, or the designs to arrange thermal conducting solids so as to obtain an optimal combination of heat transfer from one gas stream to the foam and heat conductivity through the foam to the other gas stream.

Objects of the invention are heat exchanger designs that make substantially improved use of metallic foams for gas to gas heat exchangers, opening up a range of new applications. These designs also improve capability for applications where the metallic foams are used for applications other than gas to gas heat exchange.

### SUMMARY OF THE INVENTION

The heat exchanger according to the invention includes metallic foam disposed on at least one fin made of high thermal conductivity material. The metallic foam exchanges heat with a gas stream flowing therethrough. A preferred embodiment includes a plurality of spaced apart fins with metallic foam residing between adjacent fins. The spaced apart fins may extend from a substrate.

In another preferred embodiment, the fins have a constant cross section or a varying cross section. In a preferred embodiment, the substrate is curved or straight. The foam may be thermally bonded to the fin.

### BRIEF DESCRIPTION OF THE DRAWING

FIG. 1 is a schematic diagram of foam-on-fin geometry according to an embodiment of the heat exchanger disclosed herein.

FIG. 2 is a schematic diagram of a foam-on-fin heat exchanger according to an embodiment of the invention illustrating fins that do not have a constant cross section.

FIG. 3 is a schematic illustration of a foam-on-film heat exchanger with non-linear geometry.

FIG. 4 is a schematic diagram of a foam-on-fin geometry according to an embodiment of the invention including fins and sub-fins.

FIG. 5 is a schematic diagram of the heat exchanger disclosed herein for an embodiment having two gaseous flows.

FIG. 6 is a schematic diagram of an embodiment of the invention in which the foams do not fill an entire channel.

### DESCRIPTION OF THE PREFERRED EMBODIMENT

The optimized heat exchanger in the present invention includes having metallic foam on fins. The fins are high thermally conductivity materials that are situated between regions of foam. The fins are useful for providing thermal conductivity, while the foams exchange heat with the gas streams (or between other media such as liquids). The “foam on fins” heat exchanger disclosed herein is particularly useful for gaseous media as liquids have much higher heat transfer characteristics.

Foams are inexpensive and available in a large variety of forms and materials. Materials that the foams can be made from include copper, aluminum, nickel and steels. Although the thickness of presently commercially available foams is not very large (on the order of a cm), this constraint is not very relevant to the present application to gas to gas heat transfer applications, as the relatively poor thermal conductivity of the foams prevents applications with much thicker foams.

Although the foam on fins heat exchanger is relevant for a single gaseous medium (for example, gas flowing in a channel filled with foam, with the heat transferred from the channel walls to the foam to the gas), one of the main attractions of the present application is when there is more than one medium, and in particular when there are two or more media that are gaseous, where it is desired to transfer heat from one channel to the other. It is possible that the composition of one stream is different from the other.

FIG. 1 is a schematic of an embodiment of a heat exchanger 10 where heat is exchanged between a solid and a gas flowing through a channel that includes a metallic foam 12 attached to fins 14. The fins 14 greatly increase the thermal conduction from a solid substrate 16 and the foam 12. There is heat generated in the substrate 16 or transmitted through the substrate 16. The foam 12 is in intimate contact with the high thermal conductivity fins 14. The fins 14 conduct heat to the foam 12 and are attached thermally to the substrate 16. The foams could be also attached thermally to the substrate, but most of the heat flows through the fins to the foams. There is gas or another media flowing through the foam, in the direction perpendicular to the paper. This gas cools the foam, removing heat from the fins and the substrate.

In some variations of this embodiment of the invention the coolant flows through a closed channel, and is contained within the heat exchanger 10. This is the case when the coolant is not air, (for example, when the coolant is used in a closed cycle, or when an organic coolant is used for operating a Rankine cycle). In FIG. 1 the goal is to use the heat from the substrate 16 to provide some substantial heat to a contained flow, as opposed to just cooling the substrate 16 with a limited temperature rise of the gas (for example, using open air for cooling the substrate).

There are thermal gradients through the substrate 16, through the fins 14 and through the foam 12. The characteristics of the system are adjusted in order to minimize the temperature of the substrate, for different flow through the foam, foam thermal conductivity/dimensions, and fins thermal conductivity/dimensions.

For example, there is no value in making the foams and fins longer than what is required to remove the heat. If made too long, there is little contribution of the regions far away from the substrate in removing heat from the substrate, while they still require flow rate. In addition, there would be large temperature drop across the height of the foam, with a region near the substrate with increased temperature from the heat removed from the substrate, while the region far away has a gas temperature similar to that at the inlet. Similarly, there is no point in making the width of the foam wider than necessary. If too wide, the central region of the foam does not contribute to the heat removal capability of the system. For a given width, there is an optimum width of the foam and width of the fins that results in minimization of the temperature of the substrate for a given flow rate.

The pressure drop across the foams also varies with changes in the widths of the foam and the fins, and on the height of the foam/fins (which is the same in FIG. 1). The channels that include the foam are enclosed by a material that does not have to have high temperature conductivity, just to produce a seal of the channels. The optimization of the heat exchanger includes the tradeoff between pressure drop (and pumping power) and temperature of the substrate.

The use of foams is very attractive for heat exchange with gas. The surface heat transfer coefficient h scales as h˜Nu k/D, where Nu is the Nusselt number, k is the thermal conductivity of the medium (the gas to which heat is added) and D is the diameter of the connecting elements in the foam. Thus, small values of D are desired, that is, relatively porous foams with relatively low density and high pore-per-in (PPI) density. The surface area, for a given porosity of the foam, also increases with the PPI. For the applications, PPI values from about 5 to about 60, with porosities from 70-95%, are preferred. High thermal conductivity is also desired, but it may be limited by temperature of operation, compatibility with the gas media or other operational characteristics.

If there are issues of material compatibility, the base foam material can be coated with a more appropriate material. For example, aluminum foam could be coated electrolytically with copper or nickel. The coating can be used to address corrosion or other issues if the base material is not suitable. These coatings could be catalytic or biocidal. Other forms of coating deposition would be used, including CVD.

The fins have constant thickness in FIG. 1. They do not necessarily need to be constant width. FIG. 2 shows a case with non-constant width. In the case of FIG. 2, the fins are wider in the region next to the substrate, and they are trapezoidal. The surfaces at the sides of the fins that make contact with the foam does not have to be planar as shown in FIG. 2, they could have a shape that is chosen to optimize the performance of the device.

The foams/fins can also be arranged in other than a linear geometry. FIG. 3 shows the foam-finned configuration in a cylindrical geometry. The fins are radial, with the foam in-between the fins. The fins in this case have been shown as having non-constant width (in the radial direction). In this case, the width of the foam, the radial extent of the foam, and the width of the fins need to be adjusted in order to optimize the performance of the heat exchanger.

The foam material does not have to have uniform pore density. The material can be fabricated either with varying pore density/porosity, or varying pore density can be achieved by compression of the material after manufacturing. Increasing the pore density does not increase the surface heat transfer coefficient, but it does increase the specific surface density (surface area in a given volume), and decreasing the porosity (thus, reducing the flow rate in these regions). In particular, we have increased the pore density through selective compression of the foam regions that need to be thermally attached to the fins or other surface. By compressing the foam locally (with a tool that is slightly larger than the pores), it is possible to selectively compress/deform the mesh in those sections that are closes to the walls, resulting in increased material in the region of the joint and decreasing the temperature gradient in this region. The increased area in the region of the joint also facilitates the attachment. The attachment between the foams can be either by soldering, bracing, gluing (room and low temperature applications) or any other means to thermally attach the foam to the fins.

An alternative method to increase the surface area in the region of the joint (to increase the connection between the foam and the substrate), is by sanding.

The fins could be actually cylinders attached to the substrate. The foams would have holes that fit tightly onto the surface of the cylinders, and the cylinders are attached thermally to the foam (either soldering, brazing or gluing or other technique to thermally attach the foam to the cylinders). Although cylinders/rods are mentioned, other geometries, including geometries that do not have a constant cross section, can be used to optimize the heat exchanger.

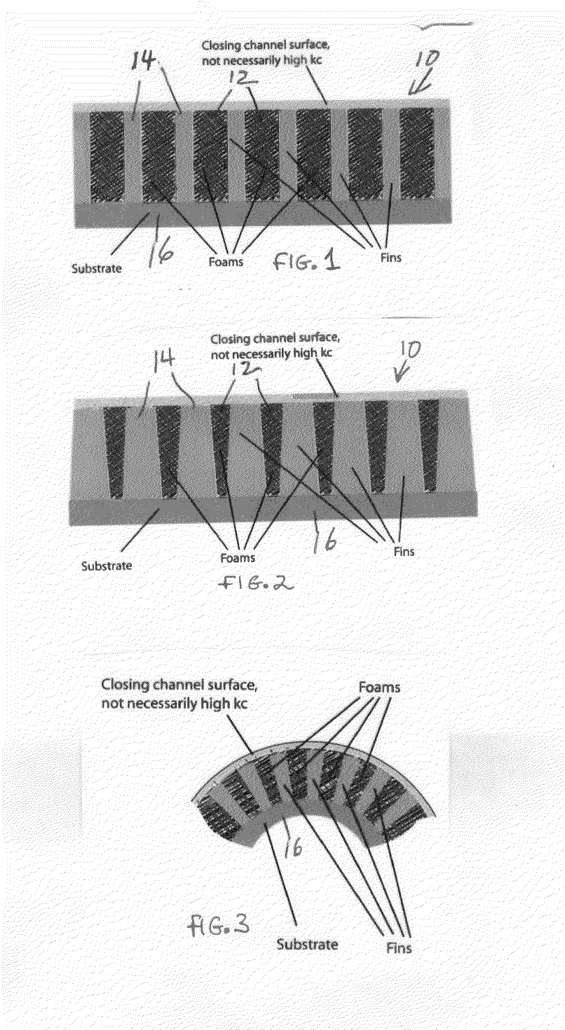

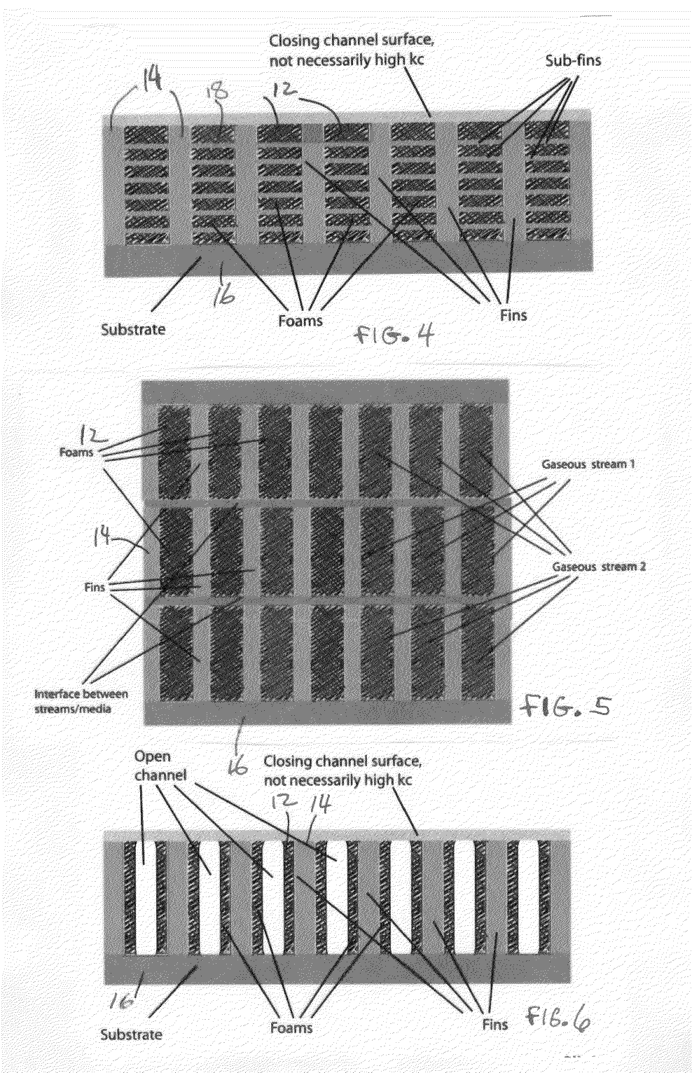

The description above includes a single fin geometry. It is possible to use sub-fins (that is, fins attached to fins) in order to more effectively get the heat to the foam. FIG. 4 shows one possible geometry. The subfins 18 can be plates normal to the fins 14, and attached to them. The foam 12 can be attached to the subfins 18, or to the subfins/fins.

The subfins 18 or the fins 14 do not need to be hermetically sealed with respect to each other (as long as it is hermetically sealed at the boundaries). If they are not sealed, it is possible and desirable that the flow from one passage can flow through a second, parallel passage. This feature is attractive if it is possible for one foam to become plugged, if the medium is carrying particulate matter/solids. The fins themselves can have breaks where the flow from one passage may flow to a second passage. This happens automatically in the case of cylinders/rods as the fins.

In addition, the subfins shown in FIG. 4 could be rods or plate sections that span the entire width of the fin-to-fin distance. The sub-fins do not need to have constant cross section.

The use of metallic foams for exchanging heat between two gas streams is shown in FIG. 5. The flows are perpendicular to the page. In this example there are two flows of stream 2 and one flow of stream 1. A range of combinations of the flows is possible and a large number of parallel paths could be used.

A preferred embodiment of the heat exchanger has the fins on an adjacent stream line up, in order to minimize the need for heat transfer along (instead of across) the interface. The interface thickness should be minimized in order to decrease the temperature gradient across the interface. If the fins were not lined up, the heat would have to flow along the interface material, increasing the temperature difference. By aligning the fins a more robust structure is developed.

Although the fins are indicated as constant cross section in FIG. 5, the use of non-constant cross section could be used. In addition, the use of fins/subfins can also be employed.

FIG. 5 shows both fins/foam on both streams with the same characteristics. In general, it is possible to adjust the geometry of each side in order to optimize the gas-to-gas heat exchanger. Thus, the fin width, the foam width, porosity and pore density, materials, and the height of one stream can be adjusted, independently of the other. If the cross section of the fins are different, as long as they line up there should be adequate heat transfer, or the cross section profile of the fins can be adjusted in order to assure that the fins across the interface have the same foot-print.

Counterflow heat exchanges are preferred. In this manner, the entropy is minimized, and the system is as efficient as possible, with the best heat recuperation.

The geometry in FIG. 5 is linear. It is possible to use other geometries, including the cylindrical geometry shown in FIG. 3. As in FIG. 5, it is important for efficient operation of the heat exchanger that the fins match across the interface.

The geometry of FIG. 5 could also have an opening between the fins allowing communication between different channels in the same stream, in order to minimize the problem with blockage. Or, alternatively, the fins could be cylinders/rods.

The optimization of the heat exchanger in the case of heat removal from the substrate includes: minimization, for a given flow rate and pressure drop, of the temperature of the substrate; for a given cross section area of the heat exchanger, divided into fins (and potentially subfins) and foams; adjust the height of the foam/fins; adjust the porosity and pore density of the foam (adjust the pore density across the foam, in the case of non-uniform pore density/porosity); if possible, adjust the flow of the coolant; optimize the system in order to minimize the temperature of the substrate.

It should be mentioned that thus far the application has been for cooling. In addition to cooling, the same principles work for heating. In the case of heating, the optimization would be in order to assure the highest temperature of the substrate.

It is clear that the optimization is dependent on the parameters, and that different parameters (for example, heat to be removed, or flow rate of the coolant) change the optimal heat exchanger. However, the system is robust, in that substantial changes in the conditions do not change the efficiency of the heat exchanger.

For the case of a heat exchanger between gaseous streams, the optimization includes: adjust the cross section for the foam/fins, on both sides of the interface (i.e., for both streams); adjust the height of each stream; adjust the porosity and pore density of each stream, in the case of constant porosity (adjust the pore density across the foal in the case of non-uniform pore density/porosity); perform the calculations for the maximum temperature of the stream that is used for cooling, and the minimize the temperature of the stream that needs to be cooled, for the required flow rate of the cooling gas and for adequate pressure drop.

For optimal heat recuperation, the flow rates of both streams need to be adjusted (or the flow rate of the cooling stream needs to be adjusted for a given flow rate of the stream that needs to be cooled), as the enthalpy change in one stream matches the enthalpy change in the second stream. Ideally, the outlet temperature of the one stream is the same as the inlet temperature of the other stream, for both ends of the heat exchanger. In some cases, it is possible to adjust the flow rate of one of the streams in order to make this the case.

As in the case for cooling the substrate, the system could be used for heating the gas, rather than cooling it. In this case, it is as with the case of cooling the gas, but with the streams reversed.

The heat exchanger allows for readily introducing changes in the conditions of the heat exchanges along the direction of flow of both streams. Thus, as both the temperature and flow velocity increase, decreased pore density, increased porosity or even decreased fin thickness could be used to minimize the pressure drop. The optimization could be used on both streams, to optimize the performance of the heat exchanger.

There are additional means by which the foams can be used to increase the heat transfer between a surface and a gas. Foams could be placed thermally anchored to the fins shown in FIGS. 1-5. However, the foams do not fill the channel as shown in FIG. 6. They have good heat exchange with the gas, and then the bulk flow, through the central region, exchanging fluid (convection) with the edge regions. This arrangement minimizes the possibility of the establishment of large boundary layers near the walls. Multiple fins and multiple foams/open channels are shown in FIG. 6. However, it is understood that a single open channel can be used, without fins. In that case, the foam is attached to the surface through which the heat flows or where the heat is generated.

It is necessary to have good thermal contact between the foams and the solid elements, either the walls of the channels, the fins or the subfins). Various means can be used to improve the contact. Limited compression on the boundaries of the foams can be employed to increase locally the density of the filaments. If a small tool, slightly larger than the largest pore size, is used to compress the foam, the foam gets compressed locally only, and the ligaments on or near the surface are deformed locally. As a consequence, the new boundary contains a larger density of filaments, as the filaments removed from the surface do not move or only move a small fraction. In this manner, with a large filament concentration near the surface, better thermal contact between the foam and the solid surface can be achieved. In the absence of local compression, most of the ligaments are at sharp angles with respect to the solid surface, limiting the thermal conductance between the foam and the solids. It should be pointed out that if the compression is over an extended region, the foam would be compressed across the entire thickness, instead of just at the surface, as is desired in order to increase the material density at the surface.

Another approach to increase the heat transfer between the solid surface and the foam (in the interface between the foam and the solid) is to smear the material at the surface of the foam. When a foam made from a material like copper is sanded, the copper is so soft that instead of being removed and polished by the sanding action, it smears along the direction of the sanding motion, on that plane. We have made almost fully dense surfaces in copper foams using this approach.

Use of these new heat exchangers could be advantageous for applications where space is at a premium, such as airborne and marine platforms. The airborne applications include auxiliary power unit turbines and turbine powered drones. The heat exchanger can be used for bottoming cycle, where the energy of the exhaust of an engine or turbine (used for propulsion, operating a compressor or for generating power) is used in order to heat a second fluid to be used in either an open or a closed Rankine cycle. In the case of alcohols, and in particular methanol, the coolant in the Rankine cycle could be the fuel, which is then used in the engine/turbine, avoiding the need for a condenser in the leg downstream from the energy producing apparatus (which could be a separate turbine).

The foam on fins heat exchanger could also be used for various applications where catalytic conversion is employed and where substantial heat transfer is required (either endothermic or exothermic reactions). In one embodiment, the foam is loaded with a catalyst for performing certain chemical reactions. In the case of alcohol fuels, the reaction could be endothermic thermal decomposition of the alcohol into hydrogen rich gases. The temperature of the catalyst (which could be subject to degradation at high temperatures) could be controlled by appropriate control of the exhaust flow, alcohol flow or additional substances flow (such as air, water). In this way enhanced heat recovery could be possible for alcohol fueled stationary engines and turbines, including the use of alcohol Rankine cycles.

Foams loaded with catalysts could be used for more efficient and compact catalytic conversion of natural gas to methanol and other liquid fuels. The natural gas is catalytically converted to a synthesis gas which is in turn converted into liquid fuels in a second catalytic process. The first catalytic process (reforming) is highly endothermic, and heat needs to be added to the system. The heat is generated by combustion of the natural gas, and efficient/compact heat exchangers would be attractive for natural gas conversion to synthesis gas. In addition, efficient/compact heat exchangers could be used for facilitating heat removal in compact structures in the second catalytic process. Fisher Tropsch and methanol synthesis, for example, are exothermic reactions that require thermal management for optimal performance. With catalysts on foams, mounted close to thermal anchors, the system is more attractive than microchannel systems.

There are also cryogenic applications of the foam on fins heat exchanger such as natural gas liquefaction.

Another application area is in gas separation. For cryogenic oxygen plants, the unused nitrogen is used to precool incoming air. Regenerators (a type of heat exchanger where the flow through the heat exchanger is cyclical and periodically changes direction) can be used. It is possible to combine regenerators and recuperators (counter-flow energy recovery heat exchanger positioned between the inlet and outlet gas streams), by placing reversible flow heat exchangers for most efficient recuperation. In this manner, there is heat exchange across the two flows during one flow direction, and then the two flows are interchanged. In this manner, in addition to heat exchange while in operation, it is possible to use changes in enthalpy in the foam/fins during one direction of flow (when the transient results in changes in temperature in the solid/porous material of the heat exchanger elements), and this enthalpy is recovered during the second part of the flow direction. In addition to heat, it is possible to have also mass exchange (for example, humidity being deposited in the porous element, recovered into the second phase).

Effective heat exchangers and/or regenerators/heat exchangers can be also beneficial for liquid air energy storage (LAES). In this case, excess power (either motive or electricity) is used to liquefy air. During the energy recovery, the cryogenic air is compressed, reheated and then the high-pressure warm air is expanded through a turbine to generate electricity. It would be effective to transfer energy from a medium for the air warm-up, that can be used during the energy storage phase for air liquefaction. In this manner, the efficiency of the LAES can be improved.

There is also application to heat exchangers for residence or building, where it is desired to have frequent exchanges in air for management of indoor air quality. In this case, there is the issue of humidity. In this case, it would be possible to reverse the flow periodically. In this manner, condensing water that is deposited on one leg of the heat exchanger while the leg serves as the outflow leg, is reintroduced into the building/residence when the flow is reversed in the heat exchanger. Thus, each leg works as a regenerator for water, while at the same time, they work as heat exchangers. This method prevents plugging up the outlet with ice, in the case of exchanging indoor air during periods of cold weather. The reverse occurs in the case of hot weather, with the water/steam remaining outdoors. In addition, some of the water (excess water) could be collected. Use of this air exchange applications includes aircraft as well as buildings.

In addition, the use of metallic foams in an exhaust heat driven reformer could be utilized in aftermarket conversion of cars and trucks as well as production vehicles. This conversion could provide a substantial increase in fuel efficiency at low cost. A metallic foam heat exchanger can be used to facilitate lean burn engine operation through exhaust heat driven alcohol reforming. The lean burn operation increases engine efficiency at low torque. Lean burn engine operation with exhaust driven alcohol reforming could increase fuel efficiency by around 20%. Higher compression ratio operation (e.g. a compression ratio of 12 or greater) could increase fuel efficiency by an additional 5-10%, resulting in a total efficiency increase of around 25-30%.

Aftermarket conversion could be facilitated by using a means to increase compression ratio that does not involve removing the engine head and replacing pistons or modifying the engine head. A means of doing this could be to use the spark plug opening as a means to add material in the engine cylinders near the head so as to reduce the cylinder volume. Means of increasing the compression ratio by insert have been described in the past [R. Hollingsworth, Compression Ratio Increasing Insert Ring, U.S. Pat. No. 2,676,580 (1952)]. However, the modification requires removal of the engine head, a substantial effort. Instead, we suggest that the material be inserted through the spark plug orifice. The insert would have to be attached to either the piston or the head, to prevent motion and associated noise with the motion. It could, in principle, be attached to an insert where the spark plugs goes, or even to a modified spark plug.

Substantial volume may be required. For example, assuming a 500 cm³ cylinder size, with a compression ratio of 10, the volume at top dead center is about 50 cm³. To increase the compression ratio by 10%, the volume of the insert would have to be ˜5 cm³. This would result in a compression ratio of ˜11. If instead the desired compression ratio is 12, then the volume is 10 cm3. The size of the insert would be relatively large. A means of providing the larger inserts would be to insert a hollow material (similar to a bladder) and fill it at high pressure with a fluid, expand it in situ, and then filled with a temperature resistance material, structural material, and sealed. The material for the insert does not have to have high structural integrity, as it is in a “hydrostatic” condition. However, it has to have substantial integrity to remain in the inserted position. A number of materials could work, including steels, a non-ferrous materials (such as aluminum or copper) (for high thermal conductivity). Composites could also be used, or biomaterials. For example, the bladder material could be steel, with a different reinforcement, such as a low melting temperature filler.

The insert should minimize wall surface to minimize heat exchange with the combustion gas. In addition, it should minimize the formation of crevices that may result in increased hydrocarbon emissions.

It is recognized that modifications and variations of the present invention will be apparent to those of skill in the art, and all such modifications and variations are included within the scope of the appended claims.

What is claimed is:

1. Heat exchanger comprising:
metallic foam disposed on at least one fin made of high thermal conductivity material, wherein the metallic foam exchanges heat with a gas stream flowing therethrough.

2. The heat exchanger of claim 1 further including a plurality of spaced apart fins with the metallic foam residing between adjacent fins.

3. The heat exchanger of claim 2 wherein the spaced apart fins extend from a substrate.

4. The heat exchanger of claim 2 wherein the fins have a constant cross-section.

5. The heat exchanger of claim 2 wherein the fins have a varying cross-section.

6. The heat exchanger of claim 2 wherein the substrate is curved.

7. The heat exchanger of claim 1 wherein the foam is thermally bonded to the fin.

8. The heat exchanger of claim 2 further including subfins extending between the fins.

9. The heat exchanger of claim 1 wherein the fin is made of copper.

10. The heat exchanger of claim 1 wherein the foam is aluminum.

11. The heat exchanger of claim 1 wherein the foam is copper.

12. The heat exchanger of claim 1 wherein different porosity foam is used in different parts of the heat exchanger.

13. The heat exchanger of claim 1 wherein one gas stream passes through a first region of the foam material and a second gas stream passes through a second region of the foam material so that the two gas streams don't mix.

14. Metallic foam coated with a catalyst.

15. The metallic foam of claim 14 wherein the catalyst is selected to convert natural gas into a synthesis gas.
